(19) United States
(12) Patent Application Publication
(10) Pub. No.: US 2020/0398610 A1
(43) Pub. Date: Dec. 24, 2020

(54) PAINT PRESERVATION DEVICE AND METHOD OF USE

(71) Applicant: Pavel Dragomir, Peoria, AZ (US)

(72) Inventor: Pavel Dragomir, Peoria, AZ (US)

(21) Appl. No.: 16/446,131

(22) Filed: Jun. 19, 2019

(51) Int. Cl. B44D 3/12

(52) U.S. Cl. CPC B44D 3/127

(57) ABSTRACT

A paint preservation device prevents leftover paint from drying by minimizing exposure of the leftover paint to air. The device may have a plunging lid for insertion into a bucket containing paint. A seal is formed between the plunging lid and the sidewall of the bucket. A hole through the lid allows air to escape when a user presses down on the lid, thereby removing the air to prevent the paint from drying. The aperture may be sealed with a cap. A tube may be attached at the aperture of the lid for extracting a smaller volume of paint from the bucket to a small container as a user presses down further on the lid, forcing paint through the tube. A method of use of a paint preservation device is also disclosed.

### BACKGROUND OF THE INVENTION

### Technical Field

This invention relates generally to painting tools and particularly to a device for preserving leftover paint during storage.

### State of the Art

Painters are often left with extra paint in a container, such as a can, a pail, or bucket (hereinafter “bucket”) after using a portion of the paint from the bucket for a painting project. It is often desirable to store such leftover paint for use on future painting projects. However, there are many drawbacks to conventional means of storing leftover paint.

Exposure to air, and particularly to oxygen, causes paint to thicken and dry out. When paint that has thickened is used for future projects, brush marks tend to be visible in the paint upon application. Dried paint is not suitable for future use and is wasted. As paint begins to dry, the surface exposed to air dries first. Portions of dried paint may break off as flakes that contaminate the undried paint, making it difficult to use the remaining paint without filtering it first. Ultimately, leftover paint may completely dry out, rendering it completely useless and wasted.

For these reasons, conventional means of storing leftover paint often involve an attempt to minimize exposure of the paint to air. For example, paint may be stored in a container covered with a piece of plastic or cellophane wrap. However, plastic or cellophane wrap is not structurally sound and is therefore easy to deform, or even tear, leaving the paint exposed to air or allowing it to spill. The most common conventional method of storing leftover paint is to leave the paint in the original bucket and simply replace the lid of the bucket. However, this method leaves the leftover paint still exposed to the air in the bucket between the paint and the lid, eventually causing the paint to dry out.

Accordingly, what is needed is a device for preserving leftover paint that is structurally sound and minimizes exposure of the paint to air.

### SUMMARY OF THE INVENTION

The present invention relates generally to painting tools and particularly to a device for preserving leftover paint during storage.

A paint preservation device prevents leftover paint from drying so the paint may be preserved for use on future painting projects. An advantage of the present invention is that it minimizes or eliminates exposure of the leftover paint to air, thereby preventing the paint from drying out.

Embodiments may comprise a bucket having an inner volume for containing paint. Embodiments of a paint preservation device further comprise a plunging lid that is configured for insertion into the inner volume of the bucket through the opening of the bucket. The plunging lid may comprise a horizontal plate having an outer edge that corresponds to the cross-sectional shape of the inner volume of the bucket to form a seal between the plunging lid and the vertical sidewall of the bucket.

The plunging lid may also comprise an aperture therethrough for allowing air to escape the inner volume of the bucket through the aperture when a user presses the plunging lid downward. Pressing down on the plunging lid increases the pressure of the air within the inner volume of the bucket and under the lid, thereby forcing the air out through the aperture. When paint is contained within the inner volume of the bucket, the air in contact with the top surface of the paint may be thus expelled from the bucket through the aperture, by a user pressing downward on the plunging lid until the lid comes into contact with the top surface of the paint, thereby minimizing or eliminating contact of the paint with air in the bucket. Embodiments of the present invention may further comprise a sealing device, such as a plug or a cap to seal the aperture.

In some embodiments, the plunging lid may further comprise a rim coupled to the horizontal plate and disposed vertically around the outer edge thereof. The rim serves to add strength and stability to the horizontal plate to prevent distortion and/or deformation of the horizontal plate. In addition, the rim may be configured to enhance the seal between the plunging lid and the inner surface of the vertical sidewall of the bucket.

It may be desirable for a user to extract a small quantity of stored paint from the bucket without excessively exposing the surface of the paint to the air. Accordingly, some embodiments further comprise a tube removably coupled to the plunging lid such that the aperture is aligned in fluid communication with the tube. In operation, when a user presses down on the plunging lid, after having expelled all of the air from the inner volume of the bucket, the paint will begin to be expelled through the aperture and into the tube. The paint may be further discharged from the tube through the second end thereof. A user may capture the discharged paint by holding the second end of the tube over another container for collecting the discharged paint.

In some embodiments, particularly those in which the bucket is of a larger size, the aperture may be large enough to receive the end of a suction hose of a paint sprayer therein. In such embodiments, a user may insert the end of the suction hose of a paint sprayer into the bucket, through the aperture, to extract paint from the bucket in response to operation of the paint sprayer.

It is understood that some embodiments do not comprise a bucket, but do comprise a plunging lid, configured for operation with a bucket, as described herein, and any of the other alternative elements of a paint preservation device, as described herein.

In some embodiments, the plunging lid may be configured for use with a conventional paint bucket, wherein the paint bucket has a lip, or rim, that extends inward from the top edge of the vertical sidewall thereof. For example, the plunging lid may be deformable, sufficient for insertion of the plunging lid into the inner volume of the paint bucket, thereby bypassing the lip thereof. The advantage of such embodiments is that the plunging lid may be used with any of a variety of existing conventional paint buckets having a lip that extends inward from the top edge of the vertical sidewall thereof.

A method of using a paint preservation device is also disclosed.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in conjunction with the Figures, wherein like reference numbers refer to similar items throughout the Figures, and:

FIG. 1A is a top perspective view of a paint preservation device, according to an embodiment;

FIG. 1B is a bottom perspective view of a paint preservation device, according to the embodiment of FIG. 1A;

FIG. 2 is an exploded view of a paint preservation device, according to an embodiment;

FIG. 3 is a perspective view of a paint preservation device, according to the embodiment of FIG. 2;

FIG. 4 is a perspective view of a paint preservation device, according to an embodiment;

FIG. 5 is a perspective view of a paint preservation device, according to an embodiment;

FIG. 6 is a perspective view of a paint preservation device, according to an embodiment;

FIG. 7 is a perspective view of a paint preservation device, according to an embodiment;

FIG. 8 is a section view of a paint preservation device, according to the embodiment of FIG. 7; and

FIG. 9 is a block diagram of steps of a method of use of a paint preservation device, according to an embodiment.

### DETAILED DESCRIPTION OF EMBODIMENTS OF THE INVENTION

As discussed above, embodiments of the present invention relate generally to painting tools and particularly to a device for preserving leftover paint during storage.

Disclosed is a paint preservation device for preserving leftover paint for storage. The device prevents leftover paint from drying so the paint may be preserved for use on future painting projects. An advantage of the present invention is that it minimizes or eliminates exposure of the leftover paint to air, thereby preventing the paint from drying out.

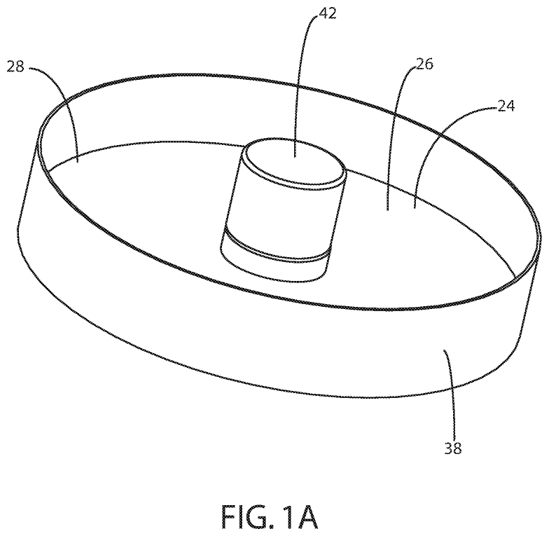

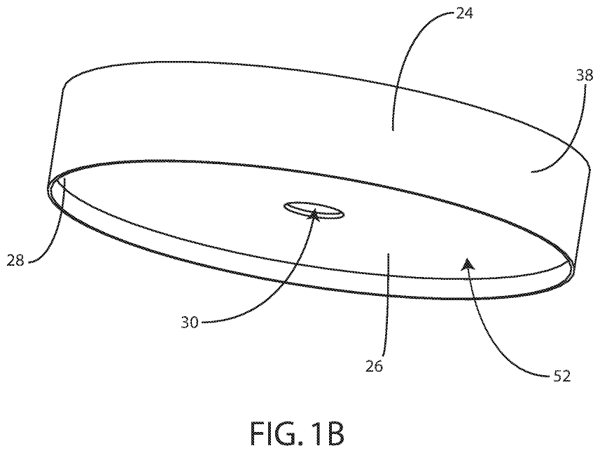

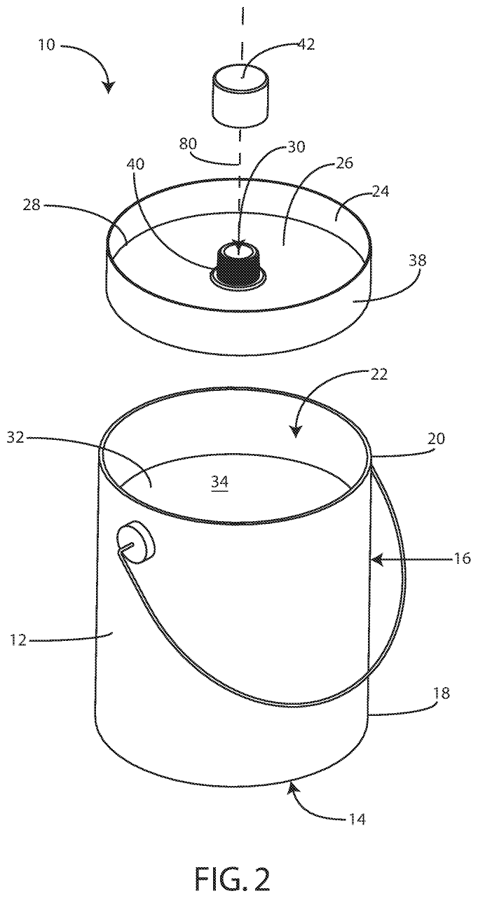

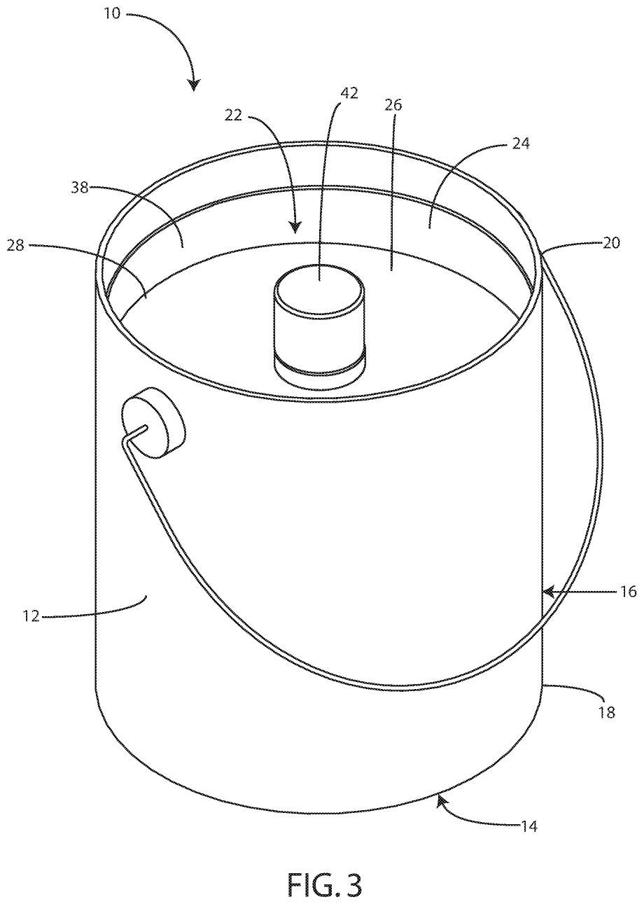

Referring to the drawings, FIGS. 1-8 depict various embodiments of a paint preservation device 10 of the present invention. As shown in FIGS. 2-3, embodiments of a paint preservation device 10 may comprise a bucket 12 having an inner volume for containing paint 32. The bucket 12 may have an inner volume defined by a bottom plate 14 and a sidewall 16 of tubular shape, having opposed bottom and top edges 18 and 20, wherein the top edge 20 defines an opening 22 of the bucket 12 and the bottom edge 18 is coupled to, and extends perpendicularly from, the bottom plate 14. In a preferred embodiment, the bucket 12 is of cylindrical shape, the sidewall 16 being perpendicular to the bottom plate 14 and the cross-sectional shape of the inner volume being uniform from the bottom edge 18 to the top edge 20. Although the bucket 12 described herein, and in the drawings, is of a circular cylindrical shape, this is not intended to be limiting. A bucket 12 of the present invention may have any interior cross-sectional shape, such as square or oval, for example, so long as the interior cross-sectional shape is uniform from the bottom to the top of the sidewall 16. Furthermore, in some embodiments, the bucket 12 does not have a lip protruding into the interior around the top edge of the bucket 12, such as is common to some conventional paint buckets. The bucket 12 may be of any volume. In some embodiments, the bucket 12 may be of any volume corresponding to any standard conventional paint bucket size, including, but not limited to, one pint, one quart, one gallon, or five gallon, for example.

Embodiments of a paint preservation device 10 may further comprise a plunging lid 24 that is configured for insertion into the inner volume of the bucket 12 through the opening 22 of the bucket 12. The plunging lid 24 may comprise a horizontal plate 26 having an outer edge 28 that corresponds to the cross-sectional shape of the inner volume of the bucket 12 to form a seal between the plunging lid 24 and the vertical sidewall 16 of the bucket 12. The plunging lid 24 is held in place within the bucket 12 by friction between the outer edge 28 thereof and the vertical sidewall 16 of the bucket 12. The plunging lid 24 may also comprise an aperture 30 therethrough for allowing air to escape the inner volume of the bucket 12 through the aperture 30 when a user presses the plunging lid 24 downward. The friction between the plunging lid 24 and the vertical sidewall 16 of the bucket 12 may be overcome by a user pressing downward on the plunging lid 24. Pressing downward on the plunging lid 24 increases the pressure of the air within the inner volume of the bucket 12 and under the plunging lid 24, thereby forcing the air out through the aperture 30. In this manner, the air in the bucket 12 may be expelled. When paint 32 is contained within the inner volume of the bucket 12, the air in contact with the top surface 34 of the paint 32 may be thus expelled from the bucket 12 through the aperture 30, by a user pressing downward on the plunging lid 24 until the plunging lid 24 comes into contact with the top surface 34 of the paint 32, thereby minimizing or eliminating contact of the paint 32 with air in the bucket 12. Embodiments of the present invention may further comprise a sealing device, such as a plug or a cap 42 to seal the aperture. The air having been expelled, the paint 32 is thereby left unexposed to the air and remains within the bucket 12 for storage without risk of drying out by exposure to the air.

In some embodiments, as shown in detail in FIGS. 1A and 1B, a plunging lid 24 may further comprise a rim 38 coupled to the horizontal plate 26 and disposed vertically around the outer edge 28 thereof. In some embodiments, the rim 38 may extend downward from the outer edge 28 of the horizontal plate 26. In some embodiments, the rim 38 may extend upward from the outer edge 28 of the horizontal plate 26. In some embodiments, as shown in FIGS. 1A and 1B, the rim 38 may extend both downward and upward from the outer edge 28 of the horizontal plate 26. The rim 38 serves to add strength and stability to the horizontal plate 26 to prevent distortion and/or deformation of the horizontal plate 26. In addition, the rim 38 may be configured to enhance the seal between the plunging lid 24 and the inner surface of the vertical sidewall 16 of the bucket 12, such as, for example, by increasing the surface area of contact between the plunging lid 24 and the vertical sidewall 16 of the bucket 12.

In some embodiments, the sealing device may be a plug (not shown) for plugging the aperture 30. In other embodiments, as shown in FIG. 2, the plunging lid 24 may comprise a threaded pipe section 40 extending upward therefrom such that the aperture 30 is aligned in fluid communication with the pipe section 40, along a longitudinal axis 80, and a threaded cap 42 may be screwed onto the pipe section 40 to seal the aperture 30. In operation, when a user has pressed down on the plunging lid 24 until the plunging lid 24 comes into contact with the top surface 34 of the paint 32, as shown in FIG. 3, a small volume of air may still remain within the threaded pipe section 40. This small volume of air within the threaded pipe section 40 may be expelled by the user continuing to press downward on the plunging lid 24, thereby forcing a corresponding volume of paint 32 upward to fill the volume of the pipe section 40 and force the air out, whereupon the user may screw on the cap 42 to seal the aperture 30 with little or no air remaining within the threaded pipe section 40. In a similar manner, any air remaining in other types of sealing devices may be removed by pressing the plunging lid 24 downward and forcing a volume of paint 30 into the sealing device to expel the air before the sealing device is engaged to seal the aperture 30.

The sealing devices described above, including a plug and a threaded cap, are not intended to be limiting. The sealing device may be any suitable sealing device known to a person of ordinary skill in the art, now or in the future, for use to seal the aperture 30. It is preferable that the sealing device be reversible, such that a sealed aperture may be unsealed and sealed again.

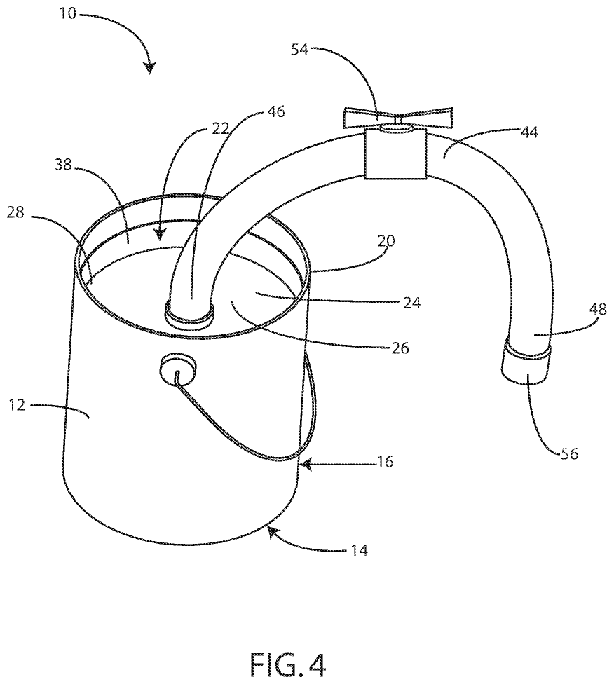

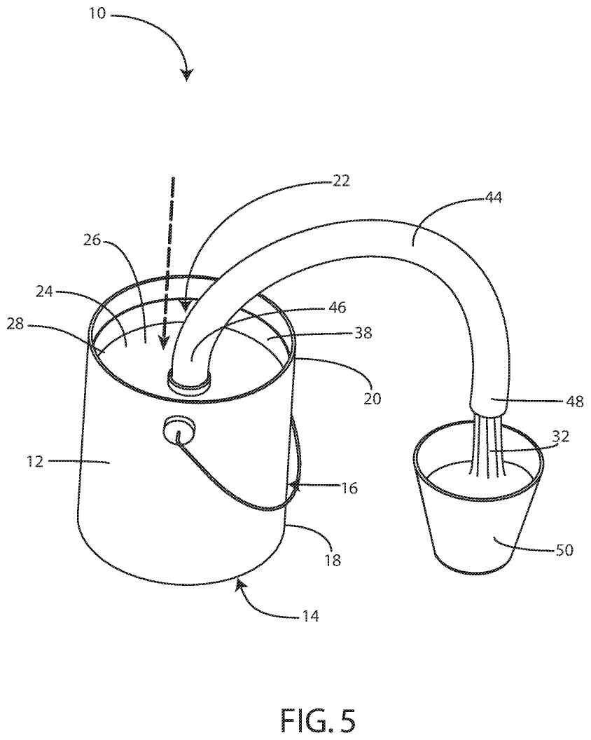

It may be desirable for a user to extract a small quantity of stored paint 32 from the bucket 12 without excessively exposing the surface 34 of the paint 32 to the air. Accordingly, referring to FIGS. 4 and 5, some embodiments further comprise a tube 44 having opposed first and second ends 46 and 48, the first end 46 thereof being removably coupled to the plunging lid 24 such that the aperture 30 is aligned in fluid communication with the tube 44. For example, in embodiments with a screw-on cap 42 for sealing the aperture 30, the cap 42 may be removed, and a tube 44, having a threaded coupling device (not shown) coupled to the first end 46 thereof, may be threaded onto the threaded pipe section 40 in the place of the cap 42. However, this is not intended to be limiting. The tube 44 may be coupled to the plunging lid 24 by any removable coupling device that is suitable for coupling the tube 44 to the plunging lid 24 such that the aperture 30 thereof is aligned in fluid communication with the tube 44, so that air or liquid expelled from the bucket 12 through the aperture 30 may be further expelled into the tube 44. In some embodiments the tube 44 may be a pipe, or pipe assembly, such as a polyvinyl chloride (PVC) pipe assembly, or the like. In other embodiments, the tube 44 may be a section of hose or other flexible tubing, such as rubber or plastic tubing, or the like. In operation, as shown in FIG. 5, when a user presses down on the plunging lid 24, in a direction indicated by the dashed arrow in FIG. 5, after having expelled all of the air from the inner volume of the bucket 12, the paint 32 will begin to be expelled through the aperture 30 and into the tube 44. The paint 32 may be further discharged from the tube 44 through the second end 48 thereof. A user may capture the discharged paint 32 by holding the second end 48 of the tube 44 over another container 50 for collecting the discharged paint 32. For example, a user may have a significant volume of paint 32, such as ½ gallon or more, stored in a 1-gallon bucket 12. The user may desire to expel a smaller volume, such as ½ pint, for example, from the 1-gallon bucket 12 to a smaller container 50. The user may press down on the plunging lid 24 to expel ½ pint of paint from the bucket 12, through the aperture 30, and discharge that volume of paint 32 from the second end 48 of the tube 44 into the smaller container 50 without exposing the paint 32 within the 1-gallon bucket 12 to the air. The user may expel any portion of the paint 32 within the bucket 12 by pressing down on the plunging lid 24.

In embodiments having a rim 38 extending only upward from the outer edge 28 of the horizontal plate 26 of the plunging lid 24, the plunging lid 24 may be pressed all the way down into the bucket 12 until it comes into contact with the bottom plate 14 of the bucket 12 to expel all, or nearly all, the paint 32 from the bucket 12. In embodiments having a rim 38 that extends downward from the outer edge 28 of the horizontal plate 26 of the plunging lid 24, a gap 52 necessarily remains between the horizontal plate 26 of the plunging lid 24 and the bottom plate 14 of the bucket 12, thereby preventing the last remaining volume of paint 32 in the gap 52 from being expelled. Leaving such a small volume of paint 32 in the bottom of the bucket 12 may or may not be desirable, depending on the application for which the paint preservation device 10 is being used.

In some embodiments, as shown in FIG. 4, the tube 44 may comprise a pressure relief valve 54 coupled therein between the first and second ends 46 and 48 thereof. The pressure relief valve 54 may be alternated between a closed position and an open position. In operation, when the tube 44 has been filled will paint 32, the paint 32 may not drain well from the tube 44, due to the surface tension of the paint 32, until a user opens the pressure relief valve 54 to allow air into the tube 44 which further allows the paint 32 within the tube 44 to drain more easily. However, this practice also allows a small remaining amount of paint 32 within the tube 44 to dry out, thus necessitating rinsing of the final remaining paint 32 from the tube 44. Such rinsing of the tube 44 may be performed, for example, after decoupling the tube 44 from the plunging lid 24 and sealing the aperture 30 with a sealing device, such as cap 42.

For embodiments in which the tube 44 is a section of hose or other flexible tubing, such as rubber or plastic tubing, or the like, it may be desirable, in operation, to strip the remaining paint 32 from the tube 44 by squeezing the tube 44 between the thumb and a finger, for example, beginning proximate the first end 46 of the tube 44 and sliding toward the second end 48 of the tube 44. This practice may also allow a small remaining amount of paint 32 within the tube 44 to dry out, thus necessitating rinsing of the final remaining paint 32 from the tube 44, as described above.

In some embodiments, the tube 44 may comprise a sealing device 56 removably coupled to the second end 48 thereof, such as, but not limited to, a plug, a cap, or the like, to prevent any remaining paint 32 within the tube 44 from drying out. Such a sealing device 56 may be alternated between an open position and a closed position.

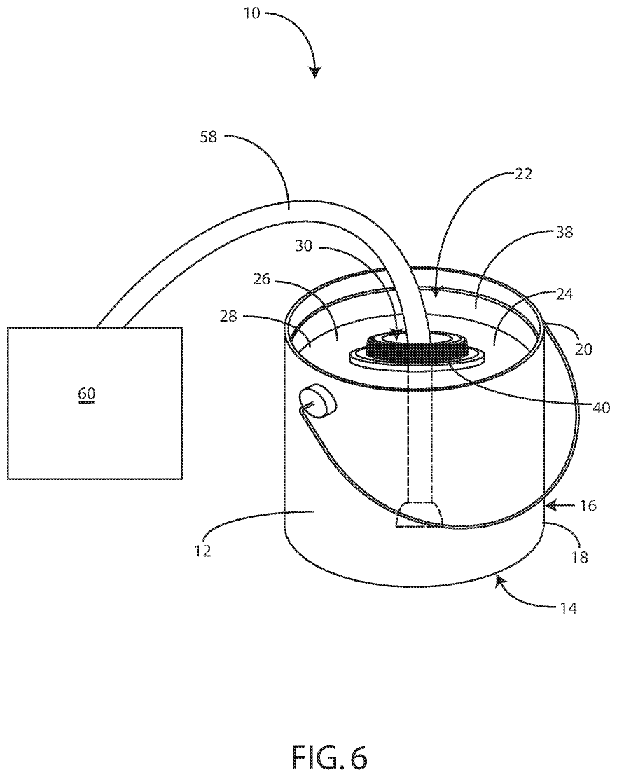

Referring to FIG. 6, in some embodiments of a paint preservation device 10, particularly those in which the bucket 12 is of a larger size, such as, without limitation, a 5-gallon bucket, for example, the aperture 30 may be large enough to receive the end of a suction hose 58 of a paint sprayer 60 therein. In such embodiments, a user may insert the end of the suction hose 58 of a paint sprayer 60 into the bucket 12, through the aperture 30, to extract paint 32 from the bucket 12 in response to operation of the paint sprayer 60. Some embodiments may be configured to seal the gap around the suction hose 58 at the aperture 30 to minimize exposure of the paint 32 to the air. For example, some embodiments may comprise a gasket (not shown), or the like, that may be removably fitted around the suction hose 58 to seal the aperture 30 around the suction hose 58.

It is understood that some embodiments do not comprise a bucket 12, but do comprise a plunging lid 24, as shown in FIGS. 1A and 1B, configured for operation with a bucket 12, as described herein, above, and any of the other alternative elements of a paint preservation device 10, as described herein, above.

Many conventional paint buckets comprise a lip or rim that extends inward from the top edge of the vertical sidewall thereof. The lip or rim is typically configured to accept a press-on lid that may be applied by tapping the lid with a mallet until it is pressed onto the lip or rim. In some embodiments, the plunging lid 24 may be configured for use with a conventional paint bucket, wherein the paint bucket has a lip or rim that extends inward from the top edge of the vertical sidewall thereof. For example, the plunging lid may be deformable, sufficient for insertion of the plunging lid into the inner volume of the paint bucket, thereby bypassing the lip or rim thereof. In some embodiments, the plunging lid 24 may be made of a deformable material, or have components, such as the outer portions thereof, made of a deformable material, such that the plunging lid 24 may be deformed for insertion into a conventional paint bucket while maintaining sufficient rigidity for operation of the plunging lid 24 as described above. For example, in some embodiments, only the outer portions of the plunging lid 24 may be deformable, sufficient for insertion of the plunging lid 24, while the center portion remains rigid. It is also contemplated that the plunging lid 24 may comprise any of a variety of mechanical elements (not shown) that are hingedly or slidingly coupled together in such a manner as to allow the diameter of the plunging lid to be variable. In such embodiments, the diameter may be reduced for insertion of the plunging lid 24 into the bucket and increased again to form a seal with the inner surface of the vertical sidewall of the bucket. The advantage of such embodiments is that the plunging lid 24 may be used with any of a variety of existing conventional paint buckets having a lip or rim that extends inward from the top edge of the vertical sidewall thereof.

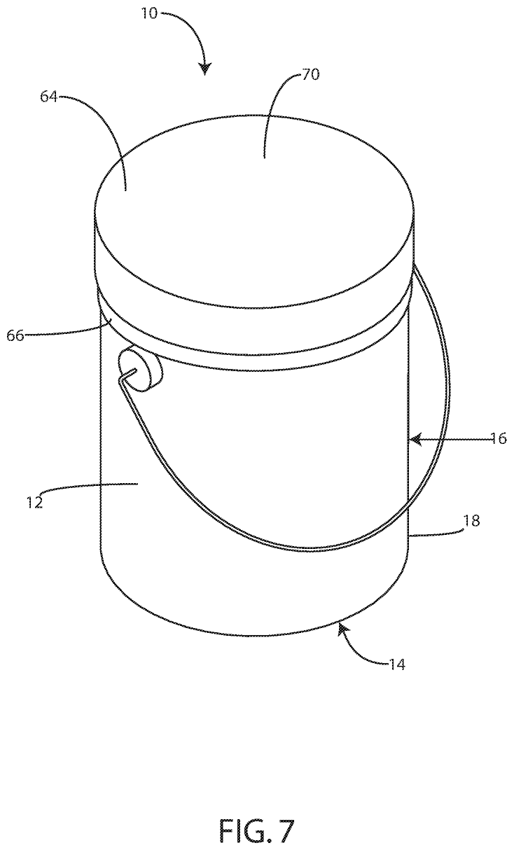

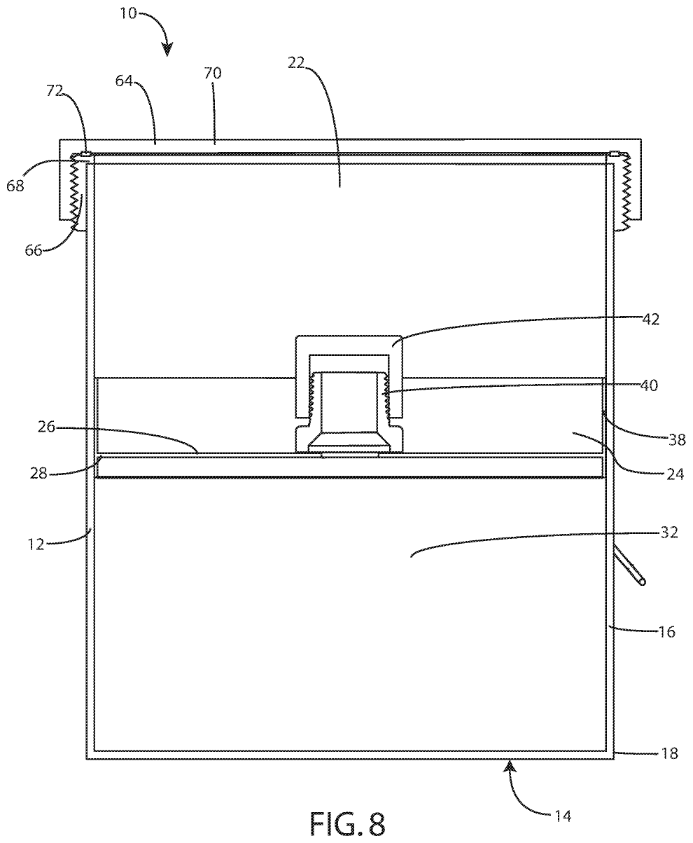

One of the disadvantages of any of a variety of conventional paint buckets having a metal lip extending inward from the top edge of the sidewall is that, even when the conventional paint bucket lid is replaced, engaging the metal lip, the metal lip may be subject to corrosion or rust. For example, many such metal lips are made of an iron alloy and the paint within the paint bucket is water-based. Rusting may occur when the metal lip is exposed to air and moisture. For this reason, some embodiments of the present invention, as shown in FIGS. 7 and 8, may further comprise a top lid assembly 64 for replacing the metal lid and lip assembly of a conventional paint bucket. Use of a top lid assembly 64 requires the user to first remove the metal lid and lip assembly from a conventional paint bucket. The bucket 12, shown in FIGS. 7 and 8, does not have a metl lid and lip assembly, or it has had the metal lid and lip assembly previously removed. A top lid assembly 64 comprises a ring 66 and a screw-on cap 70. The ring 66 is configured to be pressed onto, or otherwise coupled to, such as by an adhesive or otherwise, the top edge 20 of the vertical sidewall 16 of the paint bucket 12. In some embodiments, the ring 66 is configured to circumscribe the top edge 20 of the vertical sidewall 16 of the paint bucket 12, the ring 66 having external male threads thereabout, and a small inner lip 68 that extends over the top edge 20 of the vertical sidewall 16 in such a manner as not to extend over the opening 22 of the paint bucket 12. The lip 68 may be configured to seat the ring 66 in position at the top edge 20 of the vertical sidewall 16 without interfering with insertion of the plunging lid 24 into the bucket 12. The screw-on cap 70, having female threads, may then be threaded onto the ring 66, thereby sealing the paint bucket 12. Some embodiments may further comprise a gasket 72 or other seal coupled to one of the ring 66 or the screw-on cap 70 such that the gasket 72 or seal is disposed between the ring 66 and the screw-on cap 70 to form a seal between them. A top lid assembly 64 of the present invention has the advantage of being used when the paint bucket 12 is too full of paint to accommodate insertion of the plunging lid 24. It also provides a second layer of protection, in addition to the plunging lid 24, to minimize exposure of any paint 32 within the bucket 12 to the air. It may be made of a material that is resistant to rust and corrosion, thereby being a suitable replacement of a conventional metal paint bucket lid and lip. Furthermore, it has the advantage of providing a top enclosure to the paint bucket 12 to prevent the bucket 12 from being filled with dirt, dust, other debris, or foreign objects.

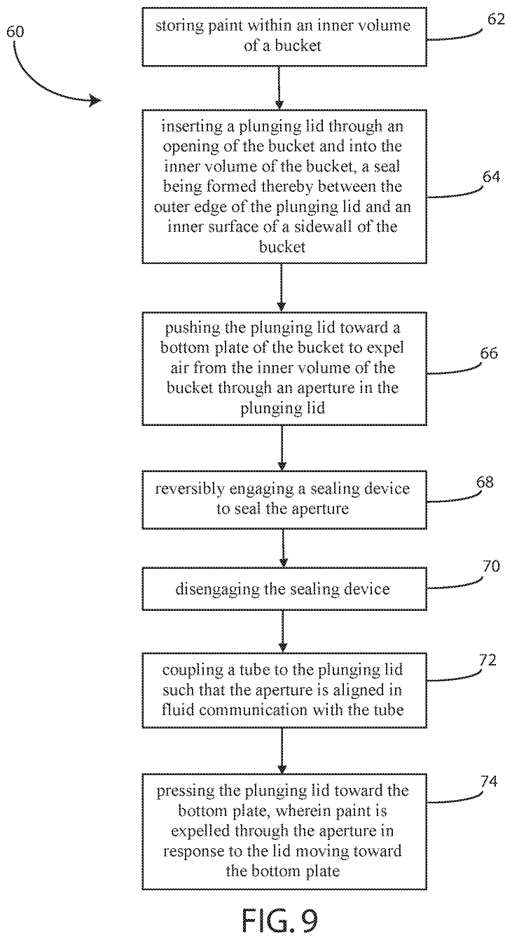

A method of using a paint preservation device is also disclosed. As shown in FIG. 9, the method 60 may comprise: storing paint within an inner volume of a bucket [Step 62]; inserting a plunging lid through an opening of the bucket and into the inner volume of the bucket, a seal being formed thereby between the outer edge of the plunging lid and an inner surface of a sidewall of the bucket [Step 64]; pushing the plunging lid toward a bottom plate of the bucket to expel air from the inner volume of the bucket through an aperture in the plunging lid [Step 66]; and reversibly engaging a sealing device to seal the aperture [Step 68].

In some embodiments, as further shown in FIG. 9, the method of use 60 may further comprise: disengaging the sealing device [Step 70]; coupling a tube to the plunging lid such that the aperture is aligned in fluid communication with the tube [Step 72]; and pressing the plunging lid toward the bottom plate, wherein paint is expelled through the aperture in response to the lid moving toward the bottom plate [Step 74].

In other embodiments, the method may further comprise: disengaging the sealing device; inserting an end of a suction hose of a paint sprayer through the aperture and into the inner volume of the bucket; and extracting paint from the inner volume of the bucket and into the suction hose in response to operation of the paint sprayer.

In other embodiments, wherein the bucket comprises a rim extending inward from around the top edge of the vertical sidewall thereof, the method may further comprise: deforming the plunging lid until the plunging lid is sufficiently small to pass through the opening of the rim; and restoring the plunging lid to its original form after it has been inserted through the opening of the bucket.

The components defining any paint preservation device may be formed of any of many different types of materials or combinations thereof that can readily be formed into shaped objects provided that the components selected are consistent with the intended operation of a paint preservation device. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as copper, zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any paint preservation device may be purchased pre-manufactured or manufactured separately and then assembled together. However, any or all the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, sewing, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

What is claimed is:

1. A paint preservation device, comprising:
a bucket with an inner volume defined by a bottom plate and a tubular sidewall, wherein the sidewall has opposed bottom and top edges, wherein the bottom edge is coupled to, and extends perpendicularly from, the bottom plate and the top edge defines an opening of the bucket, wherein a cross-sectional shape of the inner volume is uniform from the bottom edge to the top edge;
a plunging lid, inserted in the inner volume of the bucket through the opening, the plunging lid further comprising:
a horizontal plate having an outer edge, a contour of which corresponds to the cross-sectional shape of the inner volume of the bucket, wherein a seal is formed between the plunging lid and the sidewall, and wherein the position of the plunging lid relative to the bucket is maintained by friction between the plunging lid and the sidewall; and
an aperture through the horizontal plate, wherein the aperture allows air and/or liquid to escape the inner volume; and
an aperture sealing device for reversibly sealing the aperture.

2. The paint preservation device of claim 1, wherein the plunging lid further comprises a rim coupled to the horizontal plate and disposed vertically around the outer edge thereof.

3. The paint preservation device of claim 1, wherein the aperture sealing device comprises a plug partially inserted into the aperture for sealing the aperture.

4. The paint preservation device of claim 1, wherein the aperture sealing device comprises:
a threaded pipe segment coupled to the horizontal plate of the plunging lid and extending perpendicularly therefrom, wherein a longitudinal axis of the pipe segment is aligned with a longitudinal axis of the aperture through the horizontal plate; and
a threaded cap removably threaded onto the threaded pipe segment.

5. The paint preservation device of claim 1, further comprising:
a threaded pipe segment coupled to the horizontal plate of the plunging lid and extending perpendicularly therefrom, wherein a longitudinal axis of the pipe segment is aligned with a longitudinal axis of the aperture through the horizontal plate;
a tube having a first end and an opposed second end; and
a threaded coupling device coupled to the first end of the tube and removably threaded onto the threaded pipe segment.

6. The paint preservation device of claim 5, wherein the tube further comprises a pressure relief valve coupled between the first end and the second end, and wherein the pressure relief valve is rotatable between an open position and a closed position.

7. The paint preservation device of claim 1, wherein the bucket further comprises a rim extending inward from around the top edge of the sidewall thereof, and wherein the plunging lid is deformable.

8. The paint preservation device of claim 4, wherein the aperture and the threaded pipe section are configured to allow insertion of a suction hose of a paint sprayer through the threaded pipe section and the aperture and into the inner volume of the bucket for extracting paint from the inner volume of the bucket.

9. A paint preservation device, comprising:
a plunging lid, configured for insertion into an inner volume of a bucket through an opening in the bucket, the plunging lid further comprising:
a horizontal plate having an outer edge, a contour of which corresponds to the cross-sectional shape of the inner volume of the bucket; and
an aperture through the horizontal plate; and
an aperture sealing device for reversibly sealing the aperture.

10. The paint preservation device of claim 9, wherein the plunging lid further comprises a rim coupled to the horizontal plate and disposed perpendicularly around the outer edge thereof.

11. The paint preservation device of claim 9, wherein the aperture sealing device comprises a plug configured for partial insertion into the aperture for sealing the aperture.

12. The paint preservation device of claim 9, wherein the aperture sealing device comprises:
a threaded pipe segment coupled to the horizontal plate of the plunging lid and extending perpendicularly therefrom, wherein a longitudinal axis of the pipe segment is aligned with a longitudinal axis of the aperture through the horizontal plate; and
a threaded cap removably threaded onto the threaded pipe segment.

13. The paint preservation device of claim 9, further comprising:
a threaded pipe segment coupled to the horizontal plate of the plunging lid and extending perpendicularly therefrom, wherein a longitudinal axis of the pipe segment is aligned with a longitudinal axis of the aperture through the horizontal plate;
a tube having a first end and an opposed second end;
a threaded coupling device coupled to the first end of the tube and removably threaded onto the threaded pipe segment, wherein, when air is present in the inner volume of the bucket, the air is forced to escape the inner volume through the aperture and through the tube and discharged from the second end in response to a user pressing downward on the plunging lid, wherein, thereafter, when paint is present in the inner volume of the bucket, a portion of the paint is forced to escape the inner volume through the aperture and through the tube and discharged from the second end in response to a user pressing downward on the plunging lid.

14. The paint preservation device of claim 13, wherein the tube further comprises a pressure relief valve coupled between the first end and the second end.

15. The paint preservation device of claim 12, wherein the aperture and threaded pipe section are configured to allow insertion of a suction hose of a paint sprayer through the threaded pipe section and aperture and into the inner volume of the bucket for extracting paint from the inner volume of the bucket.

16. The paint preservation device of claim 9, wherein the plunging lid is deformable.

17. A method of use of a paint preservation device, comprising:
storing paint within an inner volume of a bucket;
inserting a plunging lid through an opening of the bucket and into the inner volume of the bucket, a seal being formed thereby between the outer edge of the plunging lid and an inner surface of a sidewall of the bucket;
pushing the plunging lid toward a bottom plate of the bucket to expel air from the inner volume of the bucket through an aperture in the plunging lid; and
reversibly engaging a sealing device to seal the aperture.

18. The method of claim 17, further comprising:
disengaging the sealing device;
coupling a tube to the plunging lid such that the aperture is aligned in fluid communication with the tube; and
pressing the plunging lid toward the bottom plate, wherein paint is expelled through the aperture in response to the lid moving toward the bottom plate.

19. The method of claim 17, further comprising:
disengaging the sealing device;
inserting an end of a suction hose of a paint sprayer through the aperture and into the inner volume of the bucket; and
extracting paint from the inner volume of the bucket and into the suction hose in response to operation of the paint sprayer.

20. The method of claim 17, wherein the bucket comprises a rim extending inward from around the top edge of the vertical sidewall thereof, the method further comprising:
deforming the plunging lid until the plunging lid is sufficiently small to pass through the opening of the rim; and
restoring the plunging lid to its original form after it has been inserted through the opening of the bucket.
